(19) United States
(12) Patent Application Publication
(10) Pub. No.: US 2025/0269743 A1
(43) Pub. Date: Aug. 28, 2025

(54) DUAL SOURCE ON-BOARD CHARGING SYSTEM FOR WIRELESS POWER TRANSFER

(71) Applicant: WiTricity Corporation, Midway, GA (US)

(72) Inventor: Milisav Danilovic, Watertown, MA (US)

(21) Appl. No.: 19/060,335

(22) Filed: Feb. 21, 2025

Related U.S. Application Data
(60) Provisional application No. 63/556,601, filed on Feb. 22, 2024.

(51) Int. Cl. B60L 53/122; B60L 53/126; H02J 50/12

(52) U.S. Cl. CPC B60L 53/122; B60L 53/126; H02J 50/12

(57) ABSTRACT

An apparatus for transferring power includes a first power converter coupled to a first power interface, an isolation transformer having a first transformer coil coupled to the first power converter and a second transformer coil magnetically coupled to and galvanically isolated from the first transformer coil, a second power converter coupled to the second coil of the isolation transformer and to a second power interface, a third transformer coil magnetically coupled to and galvanically isolated from the first transformer coil and magnetically coupled to the second transformer coil, and a third power interface for connecting the third transformer coil to a wireless power transmission (WPT) resonator.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 C.F.R. § 1.57.

### TECHNICAL FIELD

The following disclosure is directed to wireless power transfer, and, in particular, to wired and wireless power transfer to remote systems such as vehicles including batteries.

### BACKGROUND

Electric vehicles (EVs) are often charged through some type of wired alternating current (AC) such as household or commercial AC supply sources or special-purpose direct current (DC) sources. The wired charging connections require cables or other similar connectors that are physically connected to a power supply. Cables and similar connectors may be inconvenient or cumbersome and have other drawbacks. Wireless power transfer (WPT) systems that are capable of transferring power in free space (e.g., via a magnetic field) to be used to charge EV traction batteries may overcome some of the deficiencies of wired charging solutions.

In some designs, an electric vehicle can be configured to receive power through both wired power connections and wireless power transfer. Various dual-source electric vehicles can receive wired and wireless power either alternately or simultaneously. As such, wireless power transfer systems and methods that efficiently and effectively facilitate reception, conditioning, and storage of power by both wired connections and wireless power transfer are needed.

### SUMMARY

In general, in some aspects, an apparatus for transferring power includes a first power converter coupled to a first power interface, an isolation transformer having a first transformer coil coupled to the first power converter and a second transformer coil magnetically coupled to and galvanically isolated from the first transformer coil, a second power converter coupled to the second coil of the isolation transformer and to a second power interface, a third transformer coil magnetically coupled to and galvanically isolated from the first transformer coil and magnetically coupled to the second transformer coil, and a third power interface for connecting the third transformer coil to another device.

Implementations may include some or all of the following features, in any order or combination. The first power converter, the isolation transformer, and the second power converter may provide DC-DC conversion for transferring power bidirectionally between the first power interface and the second power interface. Capacitors may be connected between the second transformer coil and the second power converter, and when a wireless power transfer coil is connected to the third power interface, the capacitors may form a resonant circuit with the wireless power transfer coil. A first switch may be coupled between the third transformer coil and the third power interface. The capacitors may form the resonant circuit with the wireless power transfer coil when a first switch is in a configuration coupling the wireless power transfer coil to the third transformer coil through the third interface. A power bypass may route power received at the first power interface to the second power interface, bypassing the first and second power converters and isolation transformer, and the power bypass may configurable to allow power received at the third power interface to flow directly between the first power interface and the second power interface, while preventing such power from leaving the apparatus through an external input to the first power interface. A secondary-side power controller may be included. The secondary-side power controller may include an input for receiving a communication sensor signal from a wireless power transfer coil. A wireless power charging controller and a plurality of sensors may be included. The plurality of sensors may include a WiFi module, a position sensor, and a temperature sensor.

In general, in some aspects, an apparatus for transferring power includes a first power converter coupled to a first power interface, a second power converter coupled to a second power interface, an isolation transformer connected between the first power converter and the second power converter, a first switch for selectively decoupling the isolation transformer from the second power converter, and a third power interface for connecting the second power converter to another device.

Implementations may include some or all of the following features, in any order or combination. The first power converter, the isolation transformer, and the second power converter may provide DC-DC conversion for transferring power bidirectionally between the first power interface and the second power interface when the first switch is closed. Capacitors may be connected between the second transformer coil and the second power converter, and when a wireless power transfer coil is connected to the third interface, the capacitors may form a resonant circuit with the wireless power transfer coil. A power bypass may route power received at the first power interface to the second power interface, bypassing the first and second power converters and isolation transformer. The power bypass may be configurable to allow power received at the third power interface to flow directly between the first power interface and the second power interface, while preventing such power from leaving the apparatus through an external input to the first power interface.

In general, in some aspects, an apparatus for transferring power includes a first wired power interface, a second wired power interface, a wireless power transfer (WPT) interface, an AC-DC power converter, a DC-DC power converter coupled to the AC-DC power converter and to the second wired power interface, and a power bypass coupled to the first wired power interface and to the second wired power interface. The power bypass is configured to couple the first wired power interface to an input of the AC-DC power converter, and decouple the first wired power interface from the second wired power interface when an alternating current (AC) power source or load is provided to the first wired power interface, to decouple the first wired power interface from the input of the AC-DC power converter, and couple the first wired power interface to the second wired power interface when a direct current (DC) power source or load is provided to the first wired power interface, and to decouple the first wired power interface from the input of the AC-DC power converter, and couple the first wired power interface to the second wired power interface when a wireless power source or load is coupled to the WPT interface.

Implementations may include some or all of the following features, in any order or combination. The WPT interface may be selectively coupled to an internal circuit of the DC-DC power converter. The WPT interface may be selectively coupled to the first wired power interface.

In general, in some aspects, an apparatus for retrofitting wireless power transfer (WPT) into a wired electric vehicle charging system includes an on-board charger (OBC) of the wired electric vehicle charging system, a charging controller coupled to the OBC, a WPT controller coupled to the charging controller, a wireless power interface for coupling the OBC to a wireless power transfer coil, a switch configured to selectively couple the wireless power interface to the OBC under the control of the charging controller, and

a plurality of sensors. The OBC may be further configured to charge an electric vehicle using power received through the wireless power interface when the switch is closed, and to charge the electric vehicle using power received through a wired power interface of the OBC when the switch is open.

In general, in some aspects, an apparatus for retrofitting wireless power transfer (WPT) into a wired electric vehicle charging system includes an on-board charger (OBC) of the wired electric vehicle charging system, a charging controller coupled to the OBC, a WPT controller coupled to the charging controller, a plurality of capacitors, a power interface for coupling to a wireless power transfer coil, a switch coupled to the plurality of capacitors, configured to selectively couple the wireless power interface to the plurality of capacitors under the control of charging controller, and a plurality of sensors.

Various embodiments can include one or more the foregoing features, in any combination.

### BRIEF DESCRIPTION OF THE DRAWINGS

FIGS. 1-4 illustrate electric vehicle charging environments.

FIG. 5 is a schematic diagram of exemplary components of a wireless power transfer system.

FIG. 6 is a block diagram showing high-level components of a wired and wireless power transfer system.

FIGS. 7-11 are block diagrams showing example implementations of the system of FIG. 6.

### DETAILED DESCRIPTION

Wireless power transfer (WPT) for charging electric vehicles is described in detail in patents such as U.S. Pat. No. 8,933,594, titled “Wireless energy transfer for vehicles,” and U.S. Pat. No. 9,561,730, titled “Wireless power transmission in electric vehicles,” which are incorporated here by reference in their entirety. Wireless electric vehicle charging (WEVC) systems according to the SAE J2954 standard, as of the date of filing of this application, provide up to 22 kW of power at each charging station. Lower power levels, such as 11 kW and 7 KW, are commonly used, due to their compatibility with household and industrial electrical systems. At the same time, higher power levels are also used, especially for charging heavier-duty vehicles, like busses or trucks, or for charging light duty vehicles at a higher rate, and proposals have been made to extend existing WEVC standards to such power levels. Lower-power vehicles, such as scooters, golf carts, neighborhood electric vehicles (NEVs), or industrial vehicles like forklifts and automated ground vehicles (AGVs) may also be charged using WPT, but standards for doing so do not currently exist, though several are in development.

Similarly, plug-in charging systems are generally divided into three categories based on power level—Level 1 alternating current (AC) charging at up to 3.3 kW, Level 2 AC charging up to 22 kW, but more commonly 7 kW or 11 kW, and direct current (DC) fast charging, sometimes called Level 3, at power levels of 50 kW to 350 KW and higher. DC charging at Level 2 power levels is possible, but not common. Vehicles supporting Level 1 and Level 2 AC charging use a power converter on-board the vehicle to convert AC power to DC power for charging the vehicle's traction battery. The electric vehicle service equipment (EVSE), the device which provides that power from the Grid or other electricity source, may simply be a set of isolation switches and the logic circuits to control them. DC charging uses power converters external to the vehicle for converting AC power from the Grid or other power supply to DC power, which is then either provided directly to the vehicle battery or boosted to a higher voltage level by a power converter on board the vehicle, if required. Intermediate conversions to AC or other frequencies may be used, such as DC-DC conversion with an intermediate AC isolation transformer. All of the above types of charging may be bidirectional, with power from the vehicle traction battery provided to the charging system or other external load in a vehicle-to-grid (V2G), vehicle-to-home (V2H), or similar arrangement (generally V2x). In such a case, each of the power conversion stages may be bidirectional, or dedicated power conversion may be used for each direction of current flow, at any or all of the stages involved. References herein to “AC power,” “DC power,” or “AC” and “DC” alone should be understood as referring to power that is transferred as electricity having the corresponding current waveform.

Wireless vehicle charging uses power converters on both sides of the WPT connection, to convert 50 Hz or 60 Hz AC power from the Grid to, for example, 87 kHz power (referred to as low-frequency, LF, power) for conversion from electric current to a magnetic field on the transmitter side, and then from the LF magnetic field to LF electric current and then to DC power within the vehicle for charging the battery. Wireless power transfer through an electromagnetic field inherently isolates the vehicle electrical system from the Grid, while wired charging solutions require an isolation stage in the vehicle, in the external charger, or both. Sometimes the isolation is implemented within a power conversion stage, such as an isolation transformer as part of a DC-DC converter. In some examples, as described in U.S. Pat. Nos. 9,561,730 and 9,381,821, both incorporated here by reference, various power converters or components of the power converters are shared between wired and wireless charging systems.

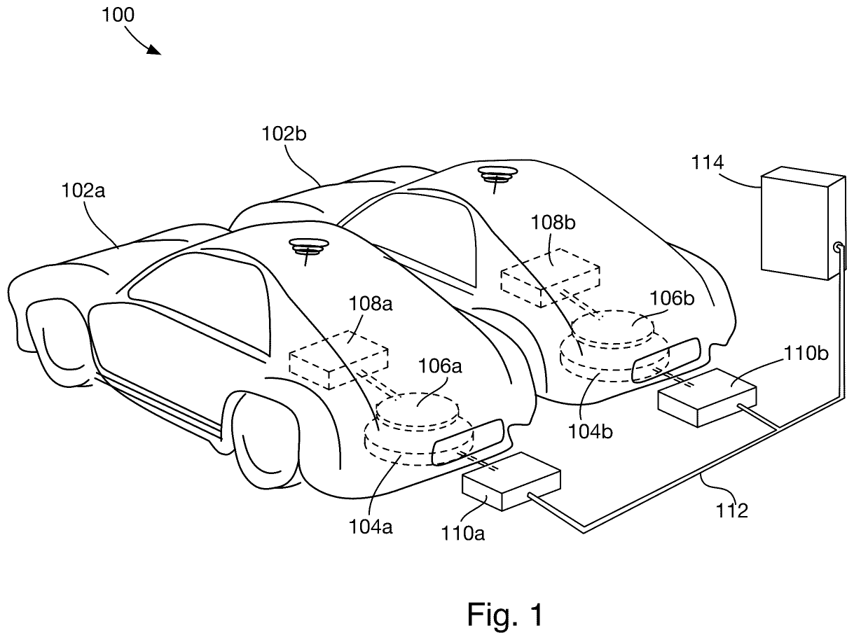

FIG. 1 shows an example of a parking facility 100 with wireless power transfer services. Two vehicles, 102a, 102b are each parked over a WPT pad 104a, 104b. Although shown as cars in FIG. 1, any type of vehicle, such as a golf cart, neighborhood electric vehicle, delivery van, bus, AGV, etc., can be charged in the same way. WPT pads 106a, 106b in the vehicles are connected to respective power converters 108a, 108b. The power converters 108a, 108b convert power received by the pads 106a, 106b to a form suitable for charging the vehicle's traction battery, not shown. In some examples, the power converters 108a, 108b may be integrated with power converters used for plug-in charging of the vehicle, commonly called on-board chargers (OBC), or other on-board vehicle components. The ground-side WPT pads 104a, 104b are shown with external power converters 110a, 110b, each connected to a power supply bus 112. The power supply bus 112 is in turn connected to a central power distribution unit 114. In some examples, the power distribution unit provides DC power to the bus 112, and the external power converters 110a, 110b include inverters, such as the multi-level inverter (MLI) described in U.S. patent application Ser. No. 18/486,830 and Ser. No. 18/486,835, both filed Oct. 13, 2023, and incorporated here by reference. The inverters provide low-frequency (LF) power signals, such as the 87 kHz signals used for wireless charging according to the SAE J2954 standard, to the pads 104a, 104b, to turn into magnetic fields for wireless power transfer. Alternatively, the power converters 110a, 110b may be implemented as DC-DC converters in combination with H-bridge inverters. In some examples, an MLI may be used at one charging station, and a DC-DC converter and inverter used at another. In some examples, the pads 104a, 104b are referred to as Ground Assembly Resonators (GAR), and the combination of the GAR with the power converter 110 or any other ground-side electronics is referred to as a Ground Assembly (GA), whether integrated or housed separately. Similarly, the WPT pads 106a, 106b may be referred to as Vehicle Assembly Resonators (VAR) and the combination of a VAR and a power converter 108 or any other vehicle-side electronics as a Vehicle Assembly (VA), again, whether integrated or housed separately. Each of the connections shown may be bi-directional, allowing the vehicles to discharge power from their batteries to the power distribution unit or other load in a V2x arrangement.

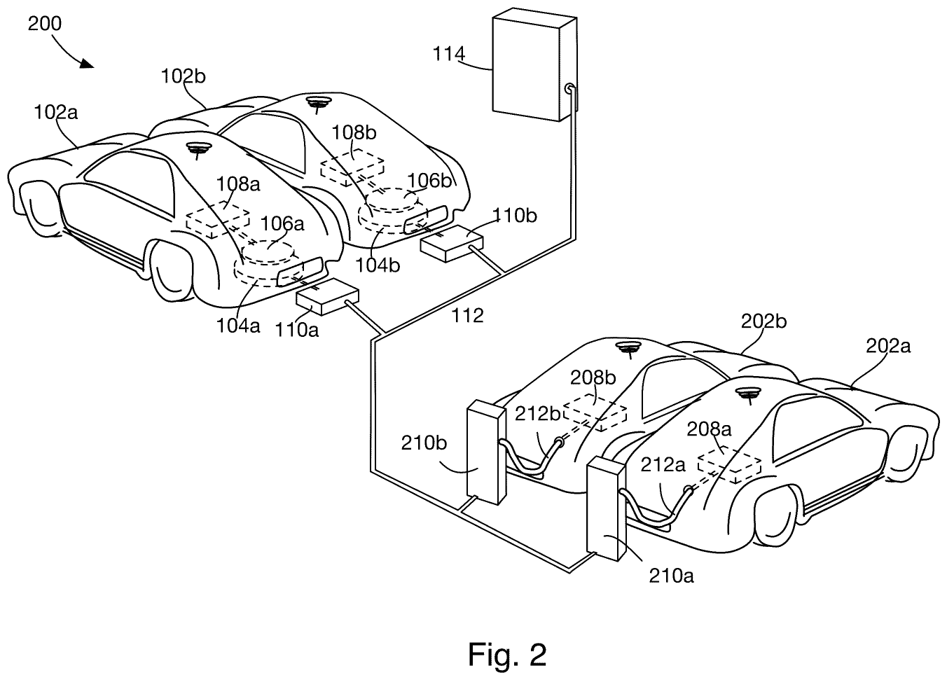

FIG. 2 shows an example of another parking facility 200 with both wireless and wired charging services. In addition to the WPT stations from FIG. 1, two wired charging stations 210a, 210b are connected to the DC bus 112. As shown, the charging stations are each plugged into a corresponding vehicle, 202a, 202b via a charging cable 212a, 212b. Within the vehicles, on-board chargers 208a, 208b provide the power from the charging stations to each vehicle's traction battery (not shown). In some examples, the charging stations 210a, 210b include inverters, such as the same multi-level inverter used in the WPT systems, to provide AC power to the vehicle. In other examples, the charging stations include DC-DC power converters, for shifting the DC voltage level of the bus 112 to the voltage required by each vehicle. In other examples, the charging stations provide DC power directly from the bus to the vehicle, with the charging stations themselves serving only as user-interface terminals and isolation switches, and the OBC in the vehicle performing any power conversion necessary to match the bus voltage to the voltage needed for charging the battery.

While the WPT stations and the wired charging stations are shown separately, both types of charging may be provided at any of the parking locations, and both AC and DC wired charging may be provided at the same station. A fleet operator may need only a single type of charging station, while other charging station operators, such as public parking facilities, may desire to provide many different types of charging.

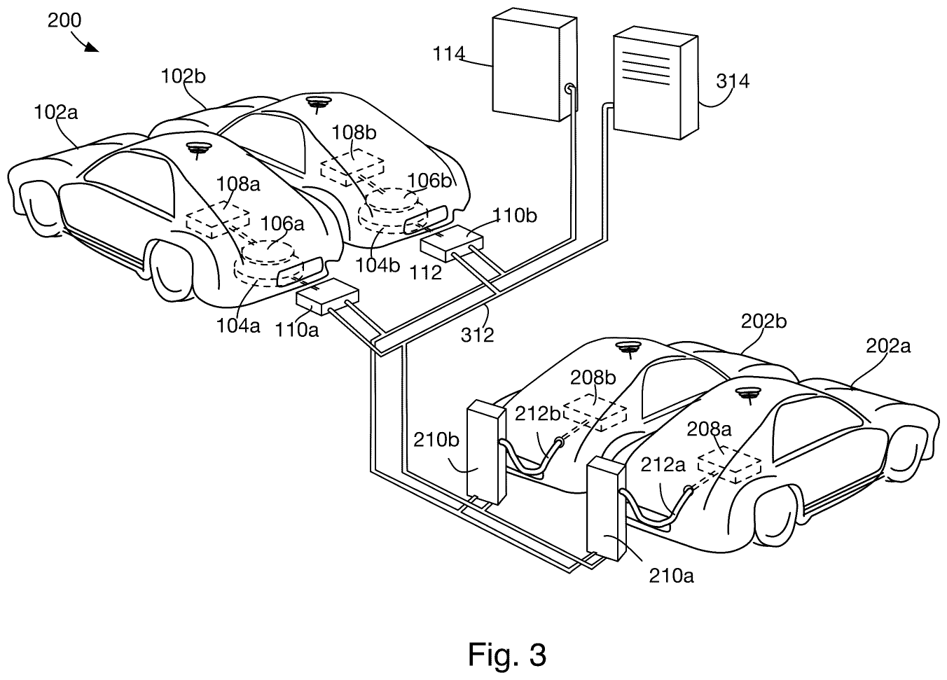

In both wired and wireless charging, it may be necessary to provide external cooling facilities. For wireless power transfer, the GARs 104a, 104b and the power converters 110a, 110b may each produce waste heat. For wired connections, any power conversion within the charging stations 210a, 210b may produce waste heat, and it may also be necessary to provide cooling within the charging cables 212a, 212b. While the vehicles themselves generally have on-board cooling facilities, they could also make use of coolant provided through the charging cables to cool the OBC while charging. FIG. 3 shows an example of the parking facility 200 from FIG. 2 in which distributed cooling is provided. A cooling bus 312 is provided in parallel to the DC bus 112, with coolant from each charging station routed back to a cooling system 314 co-located with the power distribution unit 114, or elsewhere along the bus. The cooling bus 312 may contain multiple lines of coolant, in various routing topologies, not shown, based on the needs of the system and the type of cooling provided.

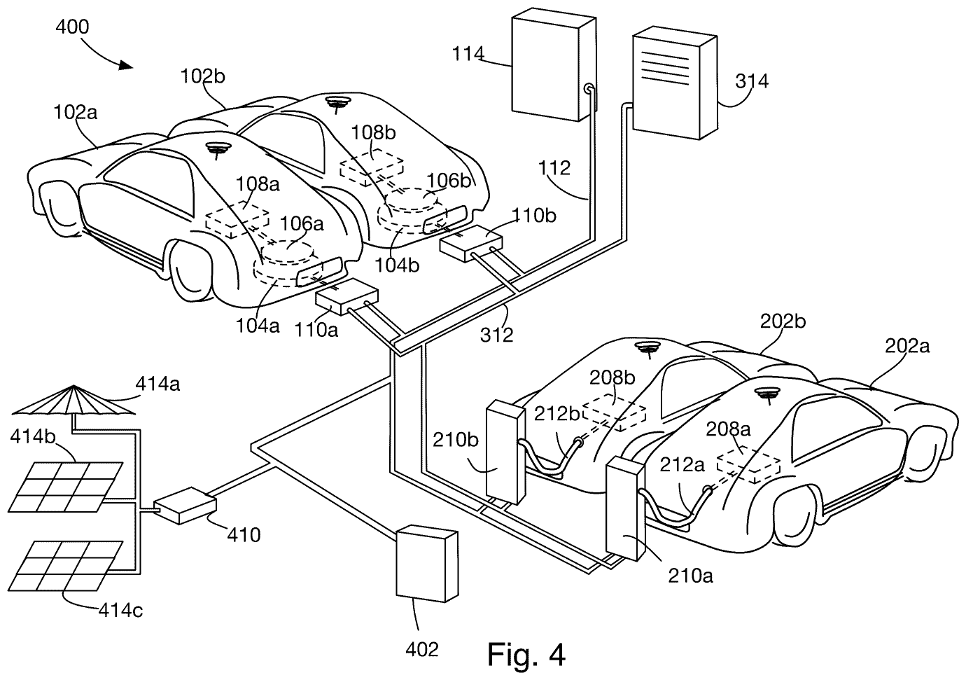

In some examples, as shown by system 400 in FIG. 4, the DC bus 112 also allows additional power sources, such as solar arrays 414a, 414b, 414c, to provide additional power for vehicle charging. In some examples, the solar arrays may be mounted over a parking area, to provide shade to the vehicles, or nearby, to provide shade to users of the vehicle while waiting for their vehicle to charge. A power converter 410 boosts the voltage level of DC power from the solar array to match that of the DC bus 112. Bi-directional devices, such as a storage battery 402, can also be connected to the bus. The storage battery 402 may include a built-in power converter (not shown) to match the voltage from the bus to the voltage of the battery. A storage battery stores excess power from the solar array during times that more solar power is produced than is required for charging vehicles and discharges this power to the vehicles or to the power distribution unit 114 as needed. Placing such a battery on the DC bus avoids the need to provide it with an inverter to provide AC power. In some examples, vehicles capable of V2x operation may provide power to the battery 402 for later distribution to other vehicles. While not shown, the battery 402 and the solar power converter 410 may also be connected to the cooling bus 312. The battery could also be charged from the Grid, such as to even out power demand during the day and to decrease surge demand if many vehicles begin charging at the same time.

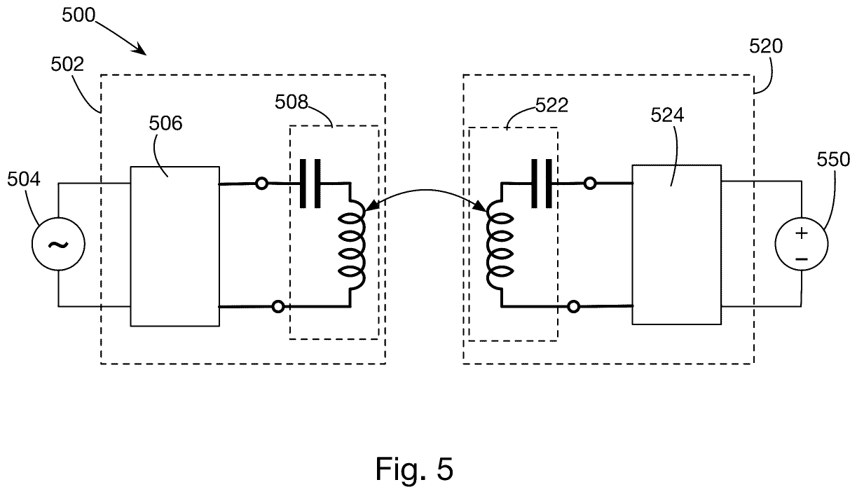

FIG. 5 shows a WPT system 500 including a ground-side WPT assembly, or GA, 502 and an vehicle-side WPT assembly, or VA, 520. The GA receives power from an external power supply 504, such as the DC bus shown above, or an electrical utility grid, which generally provides AC power. A GA power converter 506 converts the incoming power to an LF waveform suitable for transferring power wirelessly through a GA resonator 508. The GA power converter 506 supplies power to the GA resonator 508 to generate an electromagnetic field for wireless power transfer. The GA resonator 508 is shown as including a resonant capacitor and an induction coil; other topologies, including more resonant components and fixed or tunable impedance matching components, not shown, may be used. In comparison to FIGS. 1-4, the GA resonator 508 would be included within the ground-side WPT pad 104a, 104b. The GA power converter 506 corresponds to the ground-side power converters 110a, 110b. As noted above, the ground-side WPT assembly 502 is referred to as the GA regardless of whether the GA resonator and the GA power converter are integrated or separate.

On the vehicle side, the VA 520 includes a VA resonator 522 that is magnetically coupled to the GA resonator 508 so that power can be transferred between them. The VA resonator 522 provides power to a VA power converter 524. The VA power converter 524 may include, among other things, an LF/DC converter configured to convert power at an operating frequency of the resonator to DC power at a voltage level matched to the voltage level of the traction battery 550. The LF/DC converter may include, or be combined with, various conversion stages, including intermediate AC power or multiple different voltages of DC power. Example hardware may include rectifiers, inverters, and buck or boost converters. The VA power converter 524 provides the converted power to charge the traction battery 550. The VA 520 may also be configured to provide power wirelessly through the VA resonator 522 to the GA resonator 508 to feed power back to the power supply 504 in a V2x mode of operation. In comparison to FIGS. 1-4, the VA resonator 522 would be included within the vehicle-side WPT pads 106a, 106b. The VA power converter 524 corresponds to the vehicle-side power converters 108a, 108b. The vehicle-side WPT assembly 520 is referred to as the VA regardless of whether the VA resonator and the VA power converter are integrated or separate. As discussed below, the power converter and other electronics of the VA may be provided by other vehicle electronic components. In such case, this disclosure uses the term VA to refer to whatever vehicle-side WPT components remain separate from other vehicle systems.

Each of the VA resonator 522 and the GA resonator 508 may operate in transmit or receive mode based on the direction of the power transfer. Although the power output of the VA 520 is shown as going directly to a vehicle traction battery 550 in FIG. 5 and throughout, in actual practice additional electronics are likely to be involved, such as a charge management system (CMS) or battery management system (BMS) which manages the voltage and current levels of the power going to and from the traction battery to assure the most beneficial charge profile is followed. In some examples, the CMS or BMS function is performed by electronics within the VA. References to providing power to, charging, or discharging power from the traction battery should be understood to include providing power to or receiving power from whatever other electronics are involved in ultimately providing power to, or discharging power from, whatever type of energy storage is used in a given application, and the battery symbol 550 is used to represent whatever systems are ultimately connected to the power output of the vehicle charging system.

Electric vehicles equipped for wireless charging are generally also equipped for plug-in charging. While wired and wireless charging systems each include unique components not needed by the other, they also include some components in common, and others that may be optimized differently for the two modes, but for which a single version could work for both. U.S. Pat. Nos. 9,381,821 and 9,561,730, both incorporated here by reference, describe several ways in which components may be shared between wired charging systems and wireless power transfer systems. Advances in both electric vehicle design and wireless power transfer have enabled further improvements to such integration. In some examples, a vehicle may ship from the manufacturer with only a plug-in charging system, but with some of the components needed to accept wireless power included, so that a simplified VA can be connected later, with minimal additional integration efforts required.

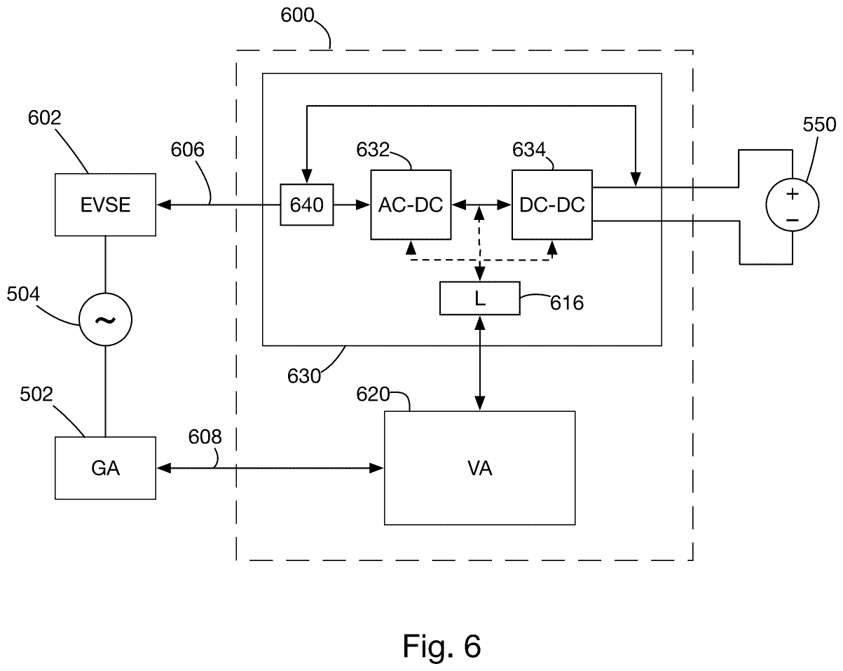

FIG. 6 illustrates an exemplary high-level functional block diagram of a vehicle charging system 600 capable of both wired and wireless power transfer between the EV and appropriate charging stations. The ground side is shown as including both an EVSE 602 and a GA 502 connected to the power supply 504. While some charging stations may include both mechanisms, only one is generally used at a time, and the systems described do not require any connection or interrelation between systems on the ground side. The GA may be any of the WPT systems shown in FIGS. 1-4, and the EVSE may be any of the wired systems shown in FIGS. 2-4, for example.

The vehicle charging system 600 includes a simplified VA 620 and a wireless-capable on-board charger (WOBC) 630, which provides power to the battery 550. Many other devices are also included in the vehicle, but are not shown for simplicity. The vehicle can exchange power with the ground side through either a wired connection 606 to the EVSE 602 or a wireless power transfer field 608 between the GA 502 and the VA 620. In the example of FIG. 6, the VA 620 is coupled to the WOBC 630, which is in turn coupled to the battery 550. As described in more detail below, the WOBC 630 converts the power received from either the EVSE 602 or the VA 620 into DC power appropriate for charging the battery 550, or, in a V2x configuration, it converts DC power from the battery 550 into either an LF power signal for wireless transfer from the VA 620 to the GA 502, or whichever type of AC or DC power signal the EVSE 602 requires over the wired connection 608. As a general example, the WOBC 630 includes an AC-DC converter 632 and a DC-DC converter 634. Each of those may be implemented as multiple power conversion components and related electronics. Additionally, the WOBC 630 includes a DC bypass 640, that allows a DC EVSE to connect directly to the battery 550. Relays within the DC bypass also prevents the DC output from the OBC from coupling to the input connection 606 when used with an AC power supply. Additional components, such as EMI filters, are not shown. The power from the VA 620 may be inserted into the WOBC's wired charging path at various points. In this example, the WOBC also includes inductors 616 used by the VA to tune output power. Including the inductors 616 in the WOBC allows use of the WOBC's existing water-cooling systems to cool the inductors 616, avoiding the need to provide water cooling connections to the VA. In subsequent figures detailing the inner workings of the vehicle charging system, details of the power supply 504, EVSE 602, GA 502, wired link 606, wireless power transfer field 608, and battery 550 are not considered, and so only the connections 606, 608 are shown.

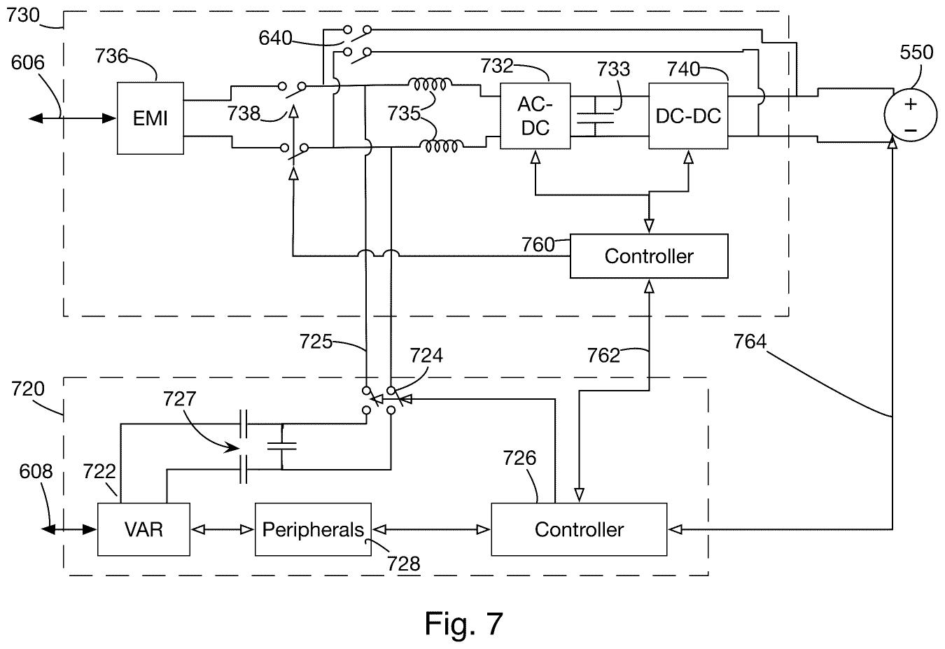

FIG. 7 shows one example implementation of the system of FIG. 6. In the example of FIG. 7, the power from the VA 720 is inserted to the wired charging path of the WOBC 730 at the input of an AC-DC converter 732. A pair of switches 738, which may be a part of the DC bypass 640 from FIG. 6, disconnect an EMI input filter 736 at the input from the wired link 606 from the AC-DC converter, while another pair of switches 724 connect the output of the VA resonator 722 to a connection 725 between the WOBC and the VA 720. A DC-DC converter 740 converts the power to the output voltage needed by the battery 550.

In this example, the VA 720 includes an impedance matching network (IMN) 727 between the VAR 722 and the switches 724. The IMN may include any appropriate topology of devices, and may be fixed or tunable. A WPT controller 726 operates the switches 724, and communicates with a WOBC controller 760 over a data link 762 to coordinate actions between the two devices. The WPT controller also communicates with the vehicle (represented by the battery 550 in the figures) over a data link 764. Among other things, the data connections are used by the VA to inform the WOBC about the state of the switches 724 and details of the power available through the WPT field 608, so that the components of the WOBC can be configured accordingly for wireless or wired charging. For example, it may be necessary to assure that the switches 724 are only closed when the switches 738 are opened, and vice-versa, so that power is not transferred between the wired connection and the VAR. The two connections 762, 764, may be provided by a single connection from the WPT controller 726 to a data bus, for example, a CAN bus, over which multiple vehicle systems communicate, and to which the WOBC controller 760 is also connected. This gives the WPT controller 726 access to vehicle data and communications.

VA peripheral systems 728 may include such components as temperature sensors, alignment and communication transceivers, and foreign object detection systems. These communicate with the WPT controller 726 to coordinate the operation of the power transfer system with the movement of the vehicle, assuring that it is properly aligned over the GA, and they provide communication between the VA and GA to manage the charging process. While the dotted line denoting the VA 720 encompasses the WPT controller 726 and other components, in some examples, the WPT controller 726 is provided with the vehicle, possibly combined with the WOBC controller 760, while the VAR, IMN, peripherals, and switches are packaged as an add-on VA product that is later connected to the power connection 725 and data connections 762, 764. Likewise, some or all of the peripherals 728 may be provided by other systems within the vehicle, and are not included in the VA 720.

In some examples, the AC-DC converter 732 in FIG. 7 is a power factor correction (PFC) system, which converts AC power to DC power while also reducing harmonic content in currents of the AC power. An output capacitor 733 typical of some types of PFCs serves as a buck capacitor for the VA in wireless mode. A set of inductors 735 at the input of the AC-DC converter, part of the overall wired charging circuit, also serve the wireless power transfer path, corresponding to inductor 616 in FIG. 6. Re-using the OBC inductors simplifies the connection 725 to the VA, removing the need for water cooling for inductors within the VA, and allowing the connection 725 to carry a simple sin-wave power signal, thus needing smaller or simpler wiring.

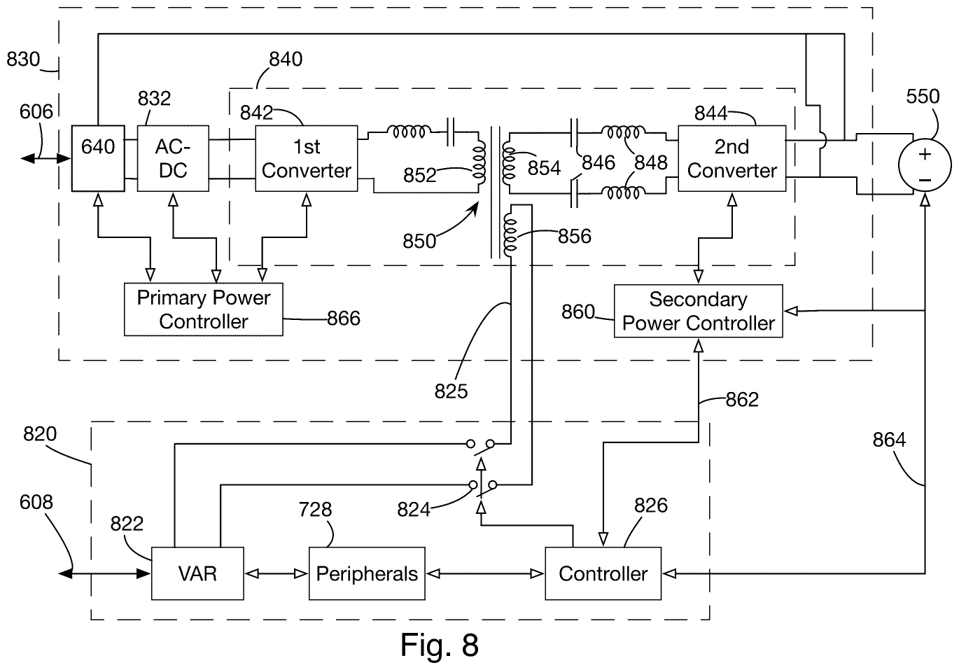

FIG. 8 shows another example implementation of the system of FIG. 6, with a VA 820 and WOBC 830. More details of the DC-DC power converter 840 are shown. In this example, power from the VA is provided to the WOBC within an isolation transformer 850 of the DC-DC converter 840. The DC-DC converter 840 includes a first converter 842 that receives DC power from an AC-DC converter 832 (when connected by the DC bypass 640) and converts it to intermediate AC power, not necessarily at the same frequency as the input AC power. The first converter 842 may be an inverter, or for a bidirectional system, a combined inverter/rectifier. The isolation transformer 850 receives the intermediate AC power at a first transformer coil 852 and induces isolated AC power within a second transformer coil 854. The isolated AC power is provided to a second converter 844 that converts it to DC power for output to the battery 550. As the complement to the first converter 842, the second converter 844 may be a rectifier for one-directional operation, or an inverter/rectifier for bidirectional operation. The power from the second transformer coil 854 passes through resonant tank capacitors 846 and inductors 848 to the second converter 844. In a wired V2x mode of operation, the process is reversed.

Within the WOBC 830, the AC-DC converter 832 and the first converter 842 are controlled by a primary-side power controller 866, such as by transmitting signals to switches of the AC-DC converter 832 and first converter 842 to control the state of such switches. A secondary-side power controller 860 controls the second converter 844 in a similar manner. Together, the first converter 842, the isolation transformer 850, and the second converter 844 provide DC-DC conversion for transferring power between the AC-DC converter 832 and the battery 550.

In some examples, the primary-side power controller 866 and the secondary-side power controller 860 include general purpose controllers, including instructions for controlling other components of the WOBC 830. The primary- and secondary-side power controllers may be combined into a single power controller controlling both converters 842 and 844. For example, the secondary-side power controller 860 or a combined controller may include an isolated input (not shown) for exchanging communications signals with components on the primary side of the WOBC.

For wireless power transfer, the LF power from the VAR 822 is provided to a third transformer coil 856, on the secondary side of the WOBC's isolation transformer 850, where it couples power to the second transformer coil 854 for output to the second converter 844. The coil 856 also serves as the WPT inductor. Power will also be coupled into the primary side of the WOBC, via the first transformer coil, and the first converter 842 and its resonant tank can be used to further manage the wirelessly-received power, with the DC bypass 640 operated to connect the DC output back to the input, while disconnecting the input 606. The AC-DC PFC 832 only processes reactive energy from the WPT system. Because the WPT field 608 provides isolation from the power supply 504, no isolation is needed on the vehicle side, within the wireless charging path. In a wireless V2x mode of operation, power flows from the battery, through the second converter 844 to the second transformer coil 854, where it is coupled to the third transformer coil 856 and in turn to the VAR 822, for wireless transfer to the GA 502.

In the example of FIG. 8, the VA 820 includes a WPT controller, 826, peripheral systems 728 as in FIG. 7, and switches 824. The switches 824 connect the VAR 822 to the third transformer coil 856 through connection 825. When the switches 824 are closed, the WOBC 830 couples power received wirelessly by the VAR 822 and provided to the WOBC via the third transformer coil 856 to the battery 550, or vice-versa. When the switches 824 are open, the WOBC 830 is decoupled from the VAR as the connection 825 is open-circuited, and wired charging can proceed normally. In some examples, only one switch, disconnecting one line of connection 825, is used. While the switches 824 are shown as internal to the VA 820, they may alternatively be housed within the WOBC 830. In some examples, the switches are integrated with the connection interface between one of the WOBC and VA and the wiring between them.

As in FIG. 7, The VA 820 can operate cooperatively with the WOBC 830 to select a charging process. The VA 820 includes a first data connection 864 between the WPT controller 826 and the battery 550 and a second data connection 862 between the WPT controller 826 and the secondary power controller 860. As before, the two data connections may both be provided by a single connection to the vehicle's data bus or other network. In some examples, the resonant tank components 846, 848 coupled between the second transformer coil 854 and the second converter 844 provide a series-tuned matching network for the wireless power transfer coil of the VAR 822 when the switch 824 is closed. Such a configuration removes the need to include an impedance matching network (IMN) in the VA, though the capacitors 846 and inductors 848 may need to be slightly modified as compared to those in an OBC that does not support wireless charging.

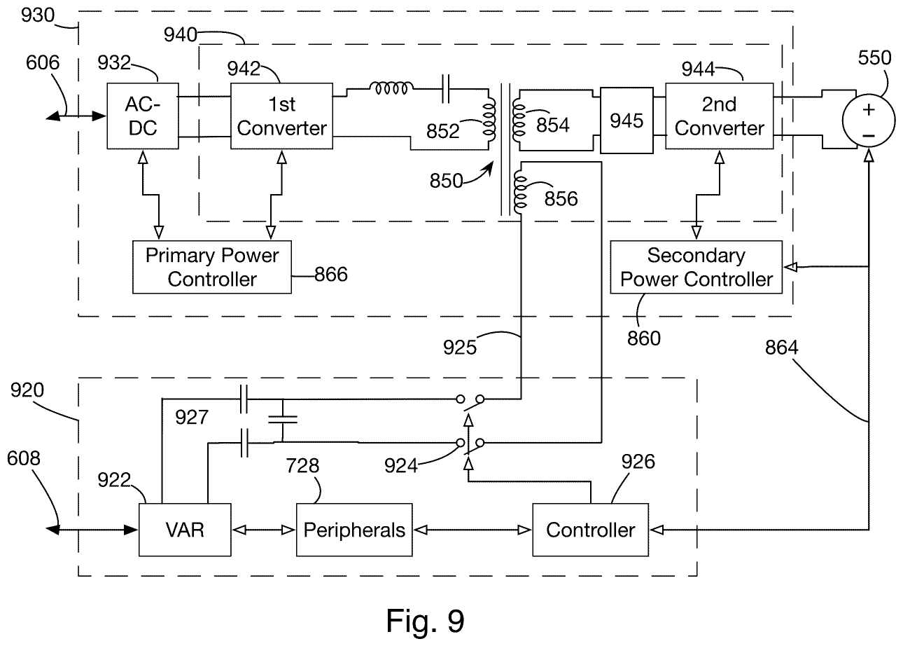

In other examples, as shown in FIG. 9, the VA 920 does include an IMN 927 between the VAR 922 and switches 924, and the resonant tank (abstracted as block 945) between the second transformer coil and the second converter is not modified. The DC bypass, not shown, is operated in the same manner as in FIG. 8 to connect the DC-DC converter's output to its input and allow both sides to be used for WPT power control. Other components of FIG. 9 operate as in FIG. 8.

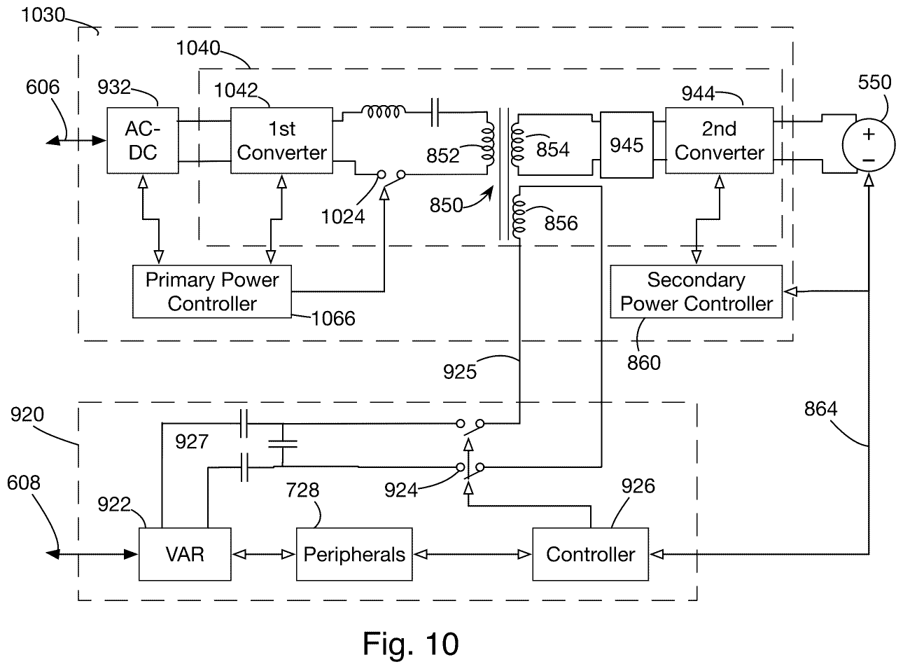

In yet another example, as shown in FIG. 10, the WOBC 1030 includes an additional relay 1024 between the first converter 1042 and the first coil 852 of the isolation transformer 850. This allows decoupling the wired charging path as in FIG. 7, while using the three-port transformer to couple the wireless path to the second converter 844 of the DC-DC converter 1040 as in FIG. 8, reducing the number of components of the WOBC 1030 that need to handle the wirelessly-received power. As in the example of FIG. 9, the IMN 927 is included in the VAR assembly.

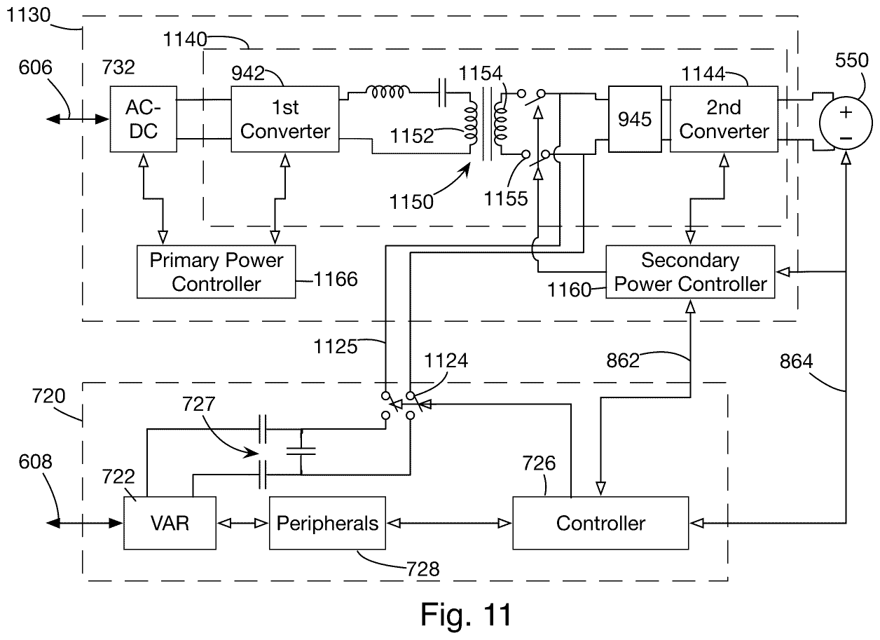

In some examples, instead of using the isolation transformer to couple power into the wired charging path, power may be directly inserted to the output side of the DC-DC converter. FIG. 11 shows an example of such a system. For the wired charging path, the WOBC 1130 includes a DC-DC converter 1140 with a first converter 942 as before, an isolation transformer 1150 with primary and secondary coils 1152, 154, resonant tank 945, and a second converter 1144. As in FIG. 9, a primary power controller 1166 controls components on the grid side of the WOBC, and a secondary power controller 1160 controls components on the battery side. The VA 720 is the same as in FIG. 7. Power from the VA 720 enters the WOBC over connection 1125 between the isolation transformer 1150 and the resonant tank 945 through a connection 1125. Interface switches 1155 serve to decouple the second transformer coil 1154 from the output side of the circuit when wireless power is available from the VA 720. Although two switches are shown, one switch may be sufficient, as disconnecting either side of the second transformer coil 1154 serves to open-circuit that component.

Because the VA 720 includes the IMN 727, the resonant tank 945 may be unchanged from a conventional OBC. In other examples, the IMN 727 is omitted, and the components of the resonant tank 945 provide series tuning of the VAR's power transfer coil as in FIG. 8.

The various illustrative logical blocks, modules, circuits, and methods described in connection with the examples disclosed above may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the described aspects.

The various illustrative blocks, modules, and circuits described in connection with disclosed controllers may be implemented or performed with a general- purpose hardware processor, a Digital Signal Processor (DSP), an Application-Specific Integrated Circuit (ASIC), a Field-Programmable Gate Array (FPGA) or other programmable logic device, discrete gate or transistor logic, discrete hardware components, or any combination thereof designed to perform the functions described herein. A general-purpose hardware processor may be a microprocessor, but in the alternative, the hardware processor may be any conventional processor, controller, microcontroller, or state machine. A hardware processor may also be implemented as a combination of computing devices.

The steps of a method and functions described above may be embodied directly in hardware, in a software module executed by a hardware processor, or in a combination of the two. If implemented in software, the functions may be stored on or transmitted as one or more instructions or code on a tangible, non-transitory, computer-readable medium. A software module may reside in Random Access Memory (RAM), flash memory, Read-Only Memory (ROM), or any other form of storage medium known in the art. A storage medium is coupled to the hardware processor such that the hardware processor can read information from, and write information to, the storage medium. In another example, the storage medium may be integral to the hardware processor. The hardware processor and the storage medium may reside in an ASIC.

Unless context dictates otherwise, items represented in the accompanying figures and terms may represent one or more items or terms, and thus reference may be made interchangeably to single or plural forms of the items and terms in this written description. Although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed. For example, the context of the above description is wireless charging of electric vehicles, but these techniques may be used in other situations where it is desired to integrate a wireless power supply to a device that is otherwise powered through a wired connection, or vice-versa.

A number of implementations have been described. Nevertheless, it will be understood that additional modifications may be made without departing from the scope of the concepts described herein, and, accordingly, other embodiments are within the scope of the following claims.

What is claimed is:

1. An apparatus for transferring power, the apparatus comprising:
a first power converter coupled to a first power interface;
an isolation transformer having a first transformer coil coupled to the first power converter, and a second transformer coil magnetically coupled to and galvanically isolated from the first transformer coil;
a second power converter coupled to the second coil of the isolation transformer and to a second power interface;
a third transformer coil magnetically coupled to and galvanically isolated from the first transformer coil and magnetically coupled to the second transformer coil; and
a third power interface for connecting the third transformer coil to another device.

2. The apparatus of claim 1, wherein the first power converter, the isolation transformer, and the second power converter provide DC-DC conversion for transferring power bidirectionally between the first power interface and the second power interface.

3. The apparatus of claim 1, further comprising capacitors connected between the second transformer coil and the second power converter,
wherein when a wireless power transfer coil is connected to the third power interface, the capacitors form a resonant circuit with the wireless power transfer coil.

4. The apparatus of claim 3, further comprising a first switch coupled between the third transformer coil and the third power interface.

5. The apparatus of claim 3, wherein the capacitors form the resonant circuit with the wireless power transfer coil when a first switch is in a configuration coupling the wireless power transfer coil to the third transformer coil through the third interface.

6. The apparatus of claim 1, further comprising a power bypass that routes power received at the first power interface to the second power interface, bypassing the first and second power converters and isolation transformer; wherein
the power bypass is configurable to allow power received at the third power interface to flow directly between the first power interface and the second power interface, while preventing such power from leaving the apparatus through an external input to the first power interface.

7. The apparatus of claim 1, wherein the apparatus further comprises a secondary-side power controller.

8. The apparatus of claim 7, wherein the secondary-side power controller comprises an input for receiving a communication sensor signal from a wireless power transfer coil.

9. The apparatus of claim 1, wherein the apparatus further comprises a wireless power charging controller and a plurality of sensors.

10. The apparatus of claim 9, wherein the plurality of sensors comprises a WiFi module, a position sensor, and a temperature sensor.

11. An apparatus for transferring power, the apparatus comprising:
a first power converter coupled to a first power interface;
a second power converter coupled to a second power interface;
an isolation transformer connected between the first power converter and the second power converter;
a first switch for selectively decoupling the isolation transformer from the second power converter; and
a third power interface for connecting the second power converter to another device.

12. The apparatus of claim 11, wherein the first power converter, the isolation transformer, and the second power converter provide DC-DC conversion for transferring power bidirectionally between the first power interface and the second power interface when the first switch is closed.

13. The apparatus of claim 11, further comprising capacitors connected between the second transformer coil and the second power converter,
wherein when a wireless power transfer coil is connected to the third interface, the capacitors form a resonant circuit with the wireless power transfer coil.

14. The apparatus of claim 11, further comprising a power bypass that routes power received at the first power interface to the second power interface, bypassing the first and second power converters and isolation transformer; wherein
the power bypass is configurable to allow power received at the third power interface to flow directly between the first power interface and the second power interface, while preventing such power from leaving the apparatus through an external input to the first power interface.

15. An apparatus for transferring power, the apparatus comprising:
a first wired power interface;
a second wired power interface;
a wireless power transfer (WPT) interface;
an AC-DC power converter;
a DC-DC power converter coupled to the AC-DC power converter and to the second wired power interface;
a power bypass coupled to the first wired power interface and to the second wired power interface, and configured to:
when an alternating current (AC) power source or load is provided to the first wired power interface, couple the first wired power interface to an input of the AC-DC power converter, and decouple the first wired power interface from the second wired power interface,
when a direct current (DC) power source or load is provided to the first wired power interface, decouple the first wired power interface from the input of the AC-DC power converter, and couple the first wired power interface to the second wired power interface,
when a wireless power source or load is coupled to the WPT interface, decouple the first wired power interface from the input of the AC-DC power converter, and couple the first wired power interface to the second wired power interface.

16. The apparatus of claim 15, wherein the WPT interface is selectively coupled to an internal circuit of the DC-DC power converter.

17. The apparatus of claim 15, wherein the WPT interface is selectively coupled to the first wired power interface.

18. An apparatus for retrofitting wireless power transfer (WPT) into a wired electric vehicle charging system, the apparatus comprising:
an on-board charger (OBC) of the wired electric vehicle charging system;
a charging controller coupled to the OBC;
a WPT controller coupled to the charging controller;
a wireless power interface for coupling the OBC to a wireless power transfer coil;
a switch configured to selectively couple the wireless power interface to the OBC under the control of the charging controller; and
a plurality of sensors.

19. The apparatus of claim 18, wherein the OBC is further configured to:
charge an electric vehicle using power received through the wireless power interface when the switch is closed; or
charge the electric vehicle using power received through a wired power interface of the OBC when the switch is open.

20. An apparatus for retrofitting wireless power transfer (WPT) into a wired electric vehicle charging system, the apparatus comprising:
an on-board charger (OBC) of the wired electric vehicle charging system;
a charging controller coupled to the OBC;
a WPT controller coupled to the charging controller;
a plurality of capacitors;
a power interface for coupling to a wireless power transfer coil;
a switch coupled to the plurality of capacitors, configured to selectively couple the wireless power interface to the plurality of capacitors under the control of charging controller; and
a plurality of sensors.
